(19) United States
(12) Patent Application Publication
(10) Pub. No.: US 2026/0296847 A1
(43) Pub. Date: Oct. 1, 2026

(54) Electric Actuation For Crane Pinned Boom

(71) Applicant: Manitowoc Crane Companies, LLC, Milwaukee, WI (US)

(72) Inventor: Stephen J. Schoonmaker, Chambersburg, PA (US)

(21) Appl. No.: 19/629,533

(22) Filed: Mar. 26, 2026

Related U.S. Application Data
(60) Provisional application No. 63/780,067, filed on Mar. 28, 2025.

(51) Int. Cl. B66C 23/70; B66C 23/42; B66C 23/88

(52) U.S. Cl. CPC B66C 23/705; B66C 23/88; B66C 23/42; B66C 2700/0371

(57) ABSTRACT

A locking head system of a crane boom actuator system includes a lock head actuator having an actuator arm configured to move in first and second directions, and an operating plate configured to move with the actuator arm. The operating plate and actuator arm are moveable from a retracted position to a neutral position and from the neutral position to an extended position. The system also includes cylinder pins connected to the operating plate by a pin linkage. Movement of the operating plate from the retracted position to the neutral position causes the cylinder pins to move from a pin retracted position to a pin extended position. Section lock arms are connected to the actuator arm by a lock arm linkage. Movement of the actuator arm from the neutral position to the extended position causes the section lock arms to move from a locking position to an unlocking position.

### CROSS-REFERENCE TO RELATED APPLICATIONS

This application claims the benefit of and priority to U.S. Provisional Patent Application No. 63/780,067, filed Mar. 28, 2025, the disclosure of which is hereby incorporated herein by reference.

### FIELD

The following description relates generally to a telescoping boom of a crane, and in particular, electric actuation of a pinning or locking head in a pinned boom of the crane.

### BACKGROUND

A length of a telescoping boom can be varied by selective movement of telescopically arranged boom sections. The telescoping sections may be extended out of a base section to increase the boom length and retracted into the base section to decrease the boom length.

A boom actuator is arranged in the base section and is operable to selectively engage a telescoping section to extend or retract the telescoping section out of or into the base section. A known boom actuator is provided as a hydraulic rod-cylinder device and includes a pinning head having coupling pins and locking arms. The coupling pins are operable to engage with and disengage from a selected telescoping section, thereby coupling and uncoupling, respectively, the hydraulic rod-cylinder device to the telescoping section. The locking arms are operable to unlock a telescoping section from, and lock the telescoping section to, an adjacent telescoping section, to permit and restrict, respectively, relative telescoping movement of the telescoping section.

Movements of the coupling pins and locking arms may be controlled by a hydraulic “trombone tube” arrangement connected to the hydraulic rod-cylinder device. However, operations of the hydraulic trombone tube may vary with entrained air and cold temperatures, which can make corresponding operations of the coupling pins and/or locking arms difficult. In addition, pressure in the trombone tube may cause movement of the rod-cylinder device which, in turn, can cause inaccurate positioning of the coupling pins and locking arms relative to a telescoping section. As a result, operations of the coupling pins and/or the locking arms may not be completed without intervention due to inaccurate positioning, and/or movements of the coupling pins and/or locking arms may be restricted, for example, by an impingement with a boom section due to a misalignment.

Electric actuators have been proposed for operating coupling pins and locking arms but challenges remain with respect to implementing such an actuator in various locking heads.

### SUMMARY

It may be desirable to provide a pinned telescoping boom in which pinning and locking operations may be performed by reciprocal movement of an electric actuator arm to actuate a first operating element for a pinning operation and a second operating element for section locking operations.

According to one aspect, a crane includes a carrier, a superstructure mounted on the carrier and having a telescoping boom having a base section and a plurality of telescope sections. A boom actuator system includes a telescoping member and a lock head actuator arranged on the telescoping member. The lock head actuator has an actuator arm configured to move in a first direction and a second direction opposite to the first direction. An operating plate is connected to the actuator arm and configured to move with the actuator arm, wherein the operating plate and actuator arm are moveable in the first direction from a retracted position to a neutral position and from the neutral position to an extended position. Cylinder pins are operably connected to the operating plate by a pin linkage, wherein movement of the operating plate from the retracted position to the neutral position causes the cylinder pins to move from a pin retracted position to a pin extended position. Section lock arms operably connected to the actuator arm by a lock arm linkage, wherein the movement of the actuator arm from the neutral position to the extended position causes the section lock arms to move from the locking position to the unlocking position. The actuator arm is spaced from the lock arm linkage moving from the retracted position to the neutral position and drives movement of the lock arm linkage moving from the neutral position to the extended position.

According to another aspect, a locking head system of a crane boom actuator system includes a lock head actuator having an actuator arm configured to move in a first direction and a second direction opposite to the first direction, and an operating plate connected to the actuator arm and configured to move with the actuator arm, wherein the operating plate and actuator arm are moveable in the first direction from a retracted position to a neutral position and from the neutral position to an extended position. Cylinder pins are operably connected to the operating plate by a pin linkage, wherein movement of the operating plate from the retracted position to the neutral position causes the cylinder pins to move from a pin retracted position to a pin extended position. Section lock arms are operably connected to the actuator arm by a lock arm linkage, wherein the movement of the actuator arm from the neutral position to the extended position causes the section lock arms to move from the locking position to the unlocking position. The actuator arm is spaced from the lock arm linkage moving from the retracted position to the neutral position and drives movement of the lock arm linkage moving from the neutral position to the extended position.

The cylinder pins are in the pin retracted position and the section lock arms are in the locking position when the actuator arm and operating plate are in the retracted position, the cylinder pins are in the pin extended position and the section lock arms are in the locking position when the actuator arm and operating plate are in the neutral position, and the cylinder pins are in the pin extended position and the section lock arms are in the unlocking position when the actuator arm and operating plate are in the extended position.

These and other features and advantages of the present invention will be apparent from the following detailed description, in conjunction with the appended claims.

### BRIEF DESCRIPTION OF THE DRAWINGS

FIG. 1 is a side view of a crane according to an embodiment;

FIG. 2 is a top view of the crane of FIG. 1;

FIG. 3 is a cross-sectional view showing an example of a telescoping boom of the crane of FIG. 1;

FIG. 4 is an enlarged view of a portion of the telescoping boom of FIG. 3 with a boom actuator system removed for clarity;

FIG. 5 is a perspective view showing an example of a locking head system of the crane of FIG. 1, with the locking head system in a retracted position;

FIG. 6 is another perspective view of the locking head system of FIG. 5;

FIG. 7A is another perspective view of the locking head system of FIG. 5 with some elements removed for clarity;

FIG. 7B is a bottom perspective view of the locking head system of FIG. 5;

FIG. 8 is a perspective view of the locking head system of the crane of FIG. 1, shown in a neutral position;

FIG. 9 is another perspective view of the locking head system of FIG. 8, with some elements removed for clarity;

FIG. 10 is a perspective view of the locking head system of the crane of FIG. 1, shown in an extended position;

FIG. 11 is another perspective view of the locking head system of FIG. 10;

FIG. 12 is another perspective view of the locking head system of FIG. 10 with some elements removed for clarity; and

FIG. 13 is a perspective view of another actuator arrangement for the locking head system.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

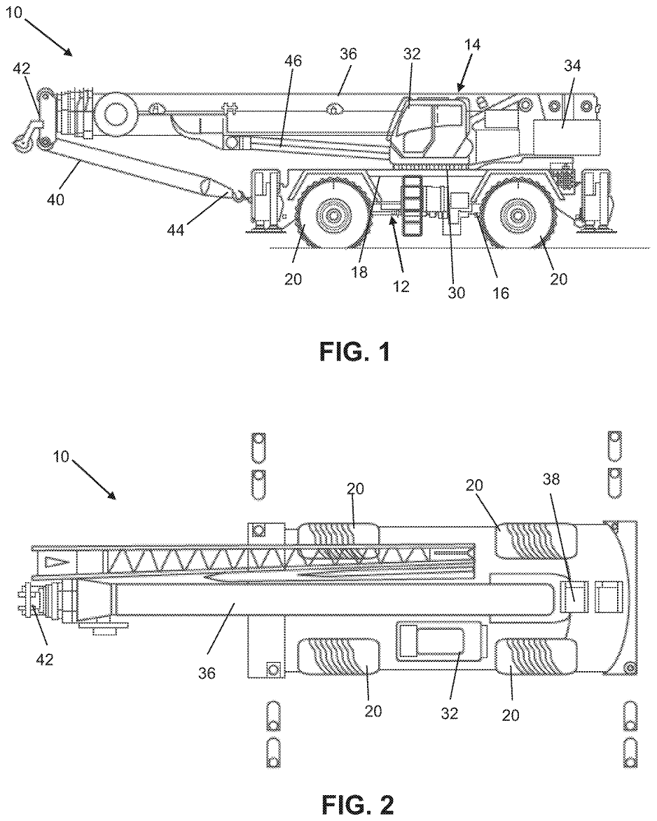

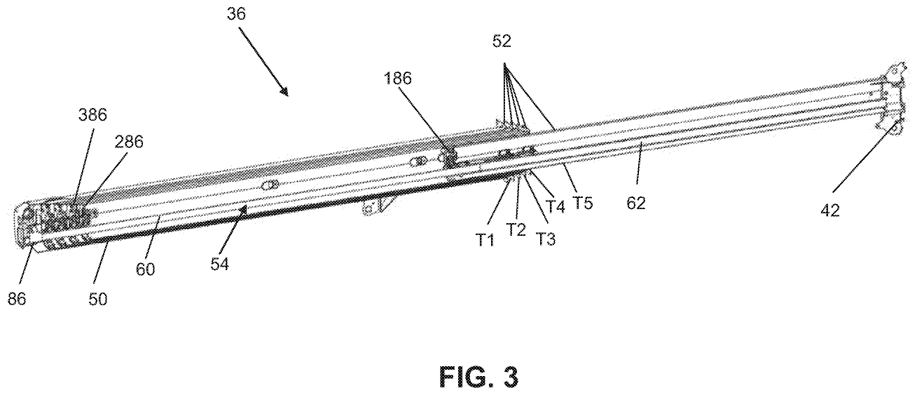

With reference to FIGS. 1 and 2, a crane 10 generally includes a carrier 12 and a superstructure 14. The superstructure 14 is rotatably mounted on the carrier 12 and configured to rotate relative the carrier 12 on a vertical axis (not shown) perpendicular to the carrier 12. The superstructure 14 may be controlled to rotate in clockwise and counterclockwise directions.

The carrier 12 includes a chassis 16 and a carrier deck 18 supported on the chassis 16. The carrier 12 may also include a plurality of axles (not labeled) connected to the chassis 16, for example, by a suspension system (not labeled), wheels 20 connected to the axles, and tires arranged on the wheels to support the carrier 12 on a support surface, such as the ground. Although not specifically shown FIGS. 1 and 2, it is appreciated that the carrier 12 may further include an engine and a transmission configured to transfer power from the engine to the wheels 20 for self-propelled movement of the crane 10. The carrier 12 may also include various other features and systems, such as a braking system, an electrical system, a lighting system and a fuel system.

The superstructure 14 is rotatably mounted on the carrier 12 with a turntable 30 arranged on an upper surface of the carrier 12. The superstructure 14 also includes an operator's cab 32, a counterweight assembly 34, a telescoping boom 36, and at least one hoist 38 operable to wind and unwind a rope 40.

The operator's cab 32 may accommodate a crane operator and may include one or more interfaces (not shown) for controlling various crane components or systems. In some examples, an interface may be operated to provide an instruction or signal to a crane control system which may be implemented as a computing device. The crane control system may then operate the crane component in the instructed manner, for example, by controlling an actuator configured to operate the crane component. The counterweight assembly 34 may accommodate the addition or removal of individual weight units to adjust the counterweight of the crane 10.

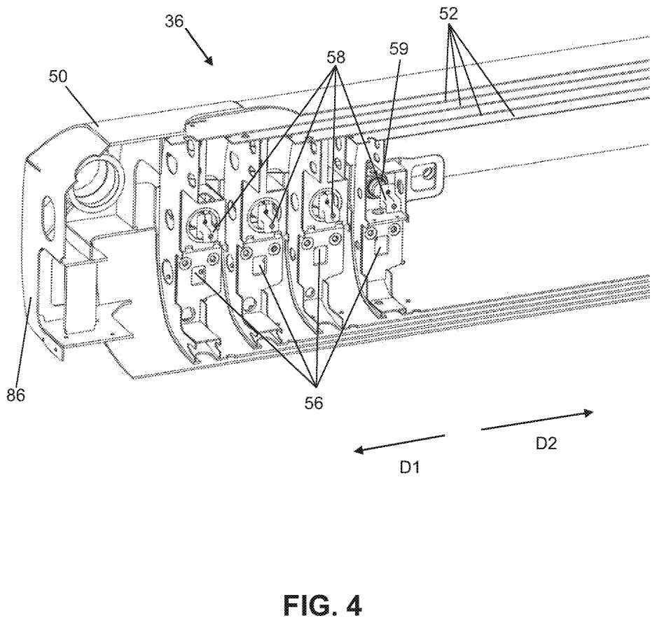

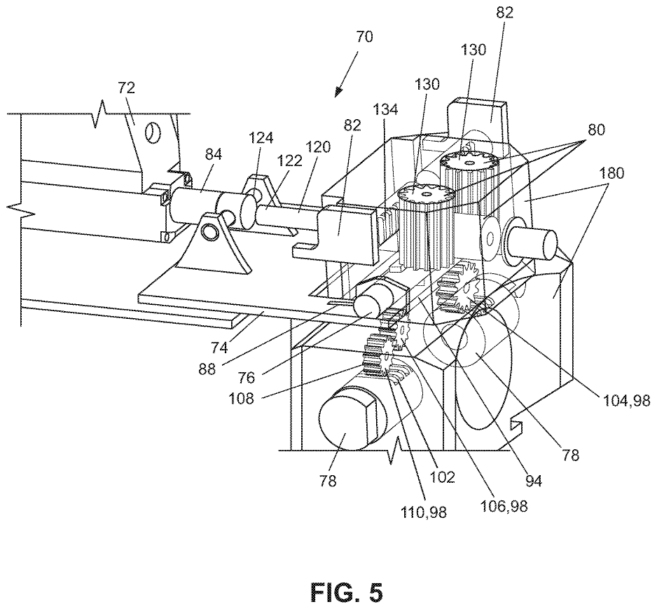

The telescoping boom 36, which is described further below with reference to FIGS. 3 and 4, may be mounted, directly or indirectly to the turntable 30, to rotate with the turntable 30 in the clockwise and counterclockwise directions about the vertical axis. Such boom movements may also be referred to as swing-right and swing-left, or slewing movements. The telescoping boom 36 may also be rotatably mounted on the turntable 30 to rotate in a vertical plane, also referred to as boom-up and boom-down, luffing or lifting movements. The telescoping boom 36 also includes a plurality of boom sections, namely a base section 50 and a plurality of telescope sections 52 configured for telescoping movement to increase or decrease a length of the boom 36, also referred to as boom-in and boom-out movements.

Although not specifically shown in the figures, in non-limiting examples, the turntable 30 may be powered to rotate by at least one hydraulic motor and may be slowed or stopped by a mechanical brake and/or hydraulic controls. Thus, the swing-left and swing-right boom movements may be controlled by operation of the hydraulic motor(s). A derricking cylinder 46 may be connected between the telescoping boom 36 and turntable 30. The derricking cylinder 46 may be hydraulically powered to extend for boom-up movements and to retract for boom-down movements. As described further below, the telescoping boom 36 may include a boom actuator having a hydraulic rod-cylinder configuration for extending and retracting the telescope sections 52 for boom-out and boom-in movements.

The at least one hoist 38 may include a main hoist, and in some examples, may further include an auxiliary hoist (not labeled). The hoist 38 generally includes a rotatable drum onto which the rope 40 may be wound and from which the rope 40 may be unwound. The drum may be driven to rotate in winding and unwinding directions, for example, by an electric motor. A hoist brake may be used to slow and/or prevent rotation of the drum. The rope 40 may extend generally along the telescoping boom 36 and can be suspended from a distal end 42 of the boom 36, also referred to as a boom nose 42. The rope 40 may be arranged on one or more sheaves at the boom nose 42. The suspended portion of the rope 40 can be connected to a lift appliance 44, such as a hook block.

The crane 10 may include one or more hydraulic systems for operating various hydraulically powered crane components, such as the turntable 30, derricking cylinder 46 and boom actuator referenced above. The hydraulic system includes various known hydraulic components, such as one or more hydraulic pumps, hydraulic lines, valves, hydraulic motors, controllers and the like.

With reference to FIGS. 3 and 4, the telescoping boom 36 includes the base section 50 and the telescope sections 52 retractable into and extendable from the base section 50. The telescope sections 52 are arranged in a telescoped configuration, such that each successive telescope section 52 has a width smaller than the width of the immediately outward adjacent section. In this manner, each telescope section 52 is extendable and retractable relative to the immediately outward adjacent boom section. In the illustrated example, the telescoping boom 36 is provided with five telescoping sections, i.e., first telescope section T1, second telescope section T2, third telescope section T3, fourth telescope section T4, and fifth telescope section T5. The first telescope section T1 section is immediately inwardly adjacent to the base section 50 and has the greatest width of the telescope sections 52. The second, third, fourth and fifth telescope sections T2, T3, T4, T5 are sequentially arranged by decreasing width such that T2 has a smaller width than T1, T3 has a smaller width than T2, T4 has a smaller width than T3 and T5 has a smaller width than T4.

The telescoping boom 36 further includes the above-referenced boom actuator system 54 configured to selectively extend and retract telescope sections 52 to adjust a length of the telescoping boom 36. The boom actuator system 54 is generally arranged within the base section 50. In the illustrated example, the boom actuator system 54 includes a hydraulic rod-cylinder configuration having a base part 60 and a slide part 62 movable relative to the base part 60, and a locking head system 70 arranged on the slide part 62. The slide part 62 is configured for substantially linear movement for extension and retraction relative to the base part 60.

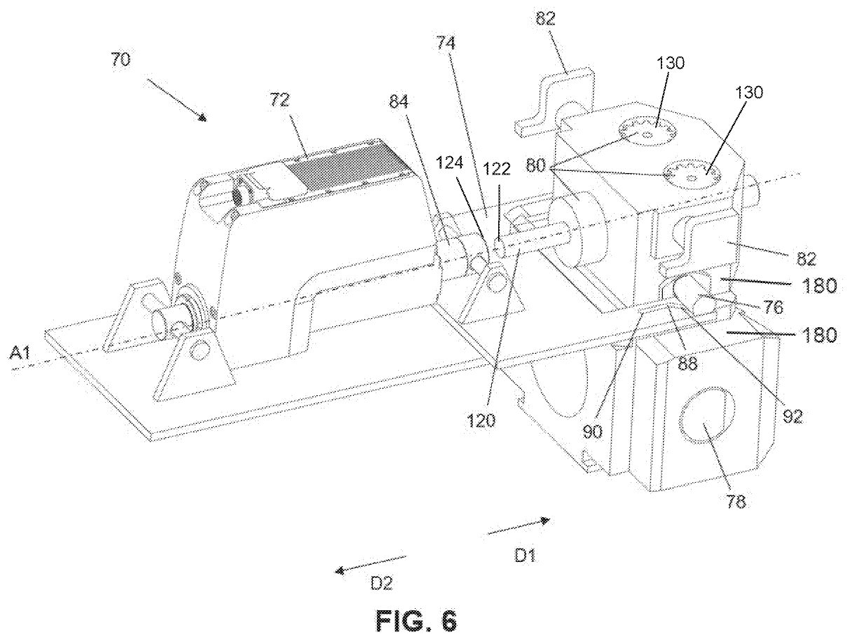

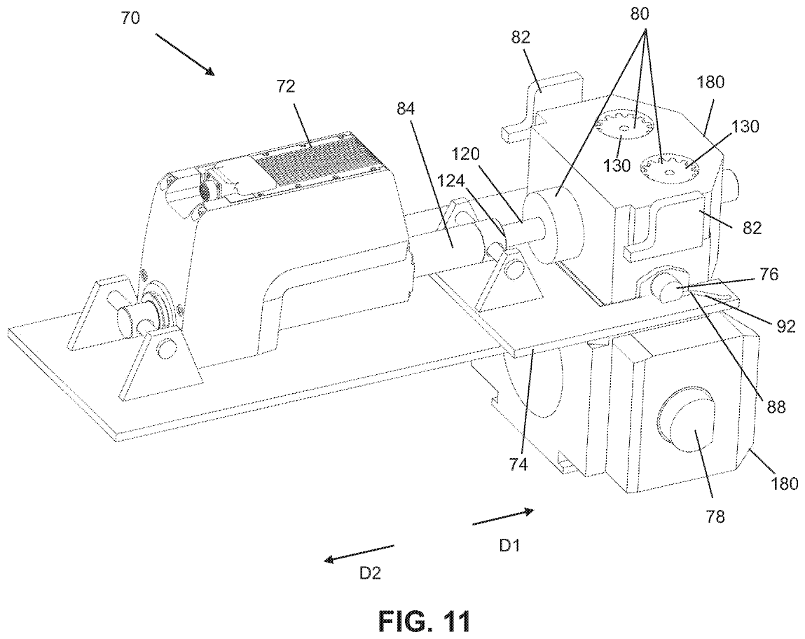

Referring generally to FIGS. 5-11, the locking head system 70 is arranged at a proximal end of the slide part 62 in the illustrated example. The locking head system 70 includes a lock head actuator 72, an operating plate 74, a pin linkage 76 and cylinder pins 78. The locking head system 70 also includes a lock arm linkage 80 and one or more section lock arms 82. The locking head system 70 may include a body block 180 to hold and guide the various components.

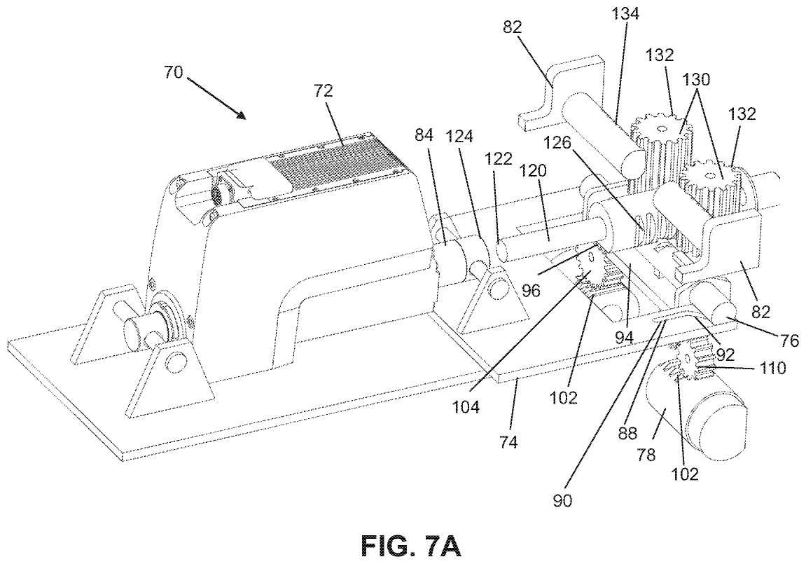

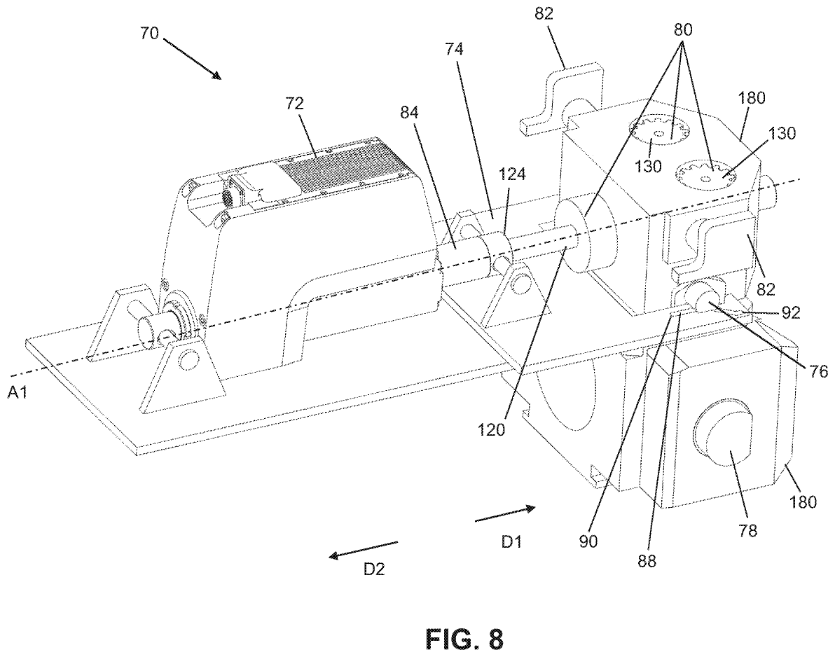

The lock head actuator 72 may be an electric actuator having an actuator arm 84 configured for movement in a first, proximal, direction D1 and a second, distal, direction D2 opposite to the first direction D1 along a longitudinal axis A1 (see FIGS. 6 and 8, for example). In the illustrated example, the actuator arm 84 can be extended in the first direction D1 generally toward a base or proximal end 86 of the telescoping boom 36 and retracted in the second direction D2 generally toward a distal end 42 of the telescoping boom 36 (see FIGS. 3 and 4).

The operating plate 74 is connected to the actuator arm 84 and configured for movement with the actuator arm 84 in the first D1 and second directions D2. The operating plate 74 includes a guide wall 88 having a first segment 90 and a second segment 92 angled relative to the first segment 90. In one example, the first segment 90 extends generally parallel to the longitudinal axis A1 and is movable in the first and second directions D1, D2 with the operating plate 74. In the illustrated example, the second segment 92 is angled relative to the first segment 90 at an obtuse angle. The guide wall 88 may be formed as a slot, groove, raised surface and the like on the operating plate 74. The second segment 92 is configured to interact with the pin linkage 76 with movement of the operating plate 74.

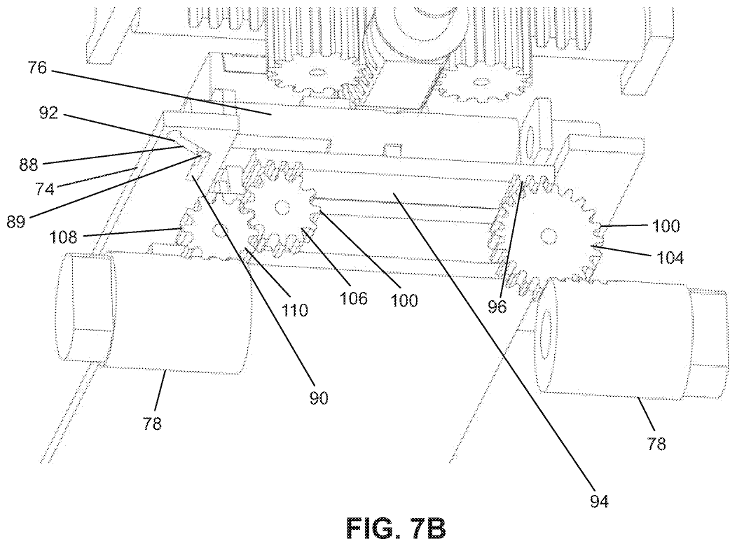

The pin linkage 76 is interconnected between the operating plate 74 and the cylinder pins 78 and may include a pin 89 (shown in FIG. 7B) that engages pin linkage 76 to the operating plate 74. The pin linkage 76 includes at least one gear interface for transferring forces from the operating plate 74 to the cylinder pins 78 to extend or retract the cylinder pins 78. In the illustrated examples, the pin linkage 76 includes a pin linkage rack 94 having pin rack teeth 96 (FIG. 7B) and at least one of the pin linkage gears 98 has gear teeth 100 configured for meshed engagement with the pin rack teeth 96. The cylinder pins 78 include pin teeth 102 configured to interact with the gear teeth 100 of one of the pin linkage gears 98. In operation, lateral movement of the pin linkage rack 94 causes the pin linkage gears 98 to rotate. Rotation of the pin linkage gears 98 causes lateral movement of the cylinder pins 78 by engagement between the pin linkage gear teeth 100 and the pin teeth 102.

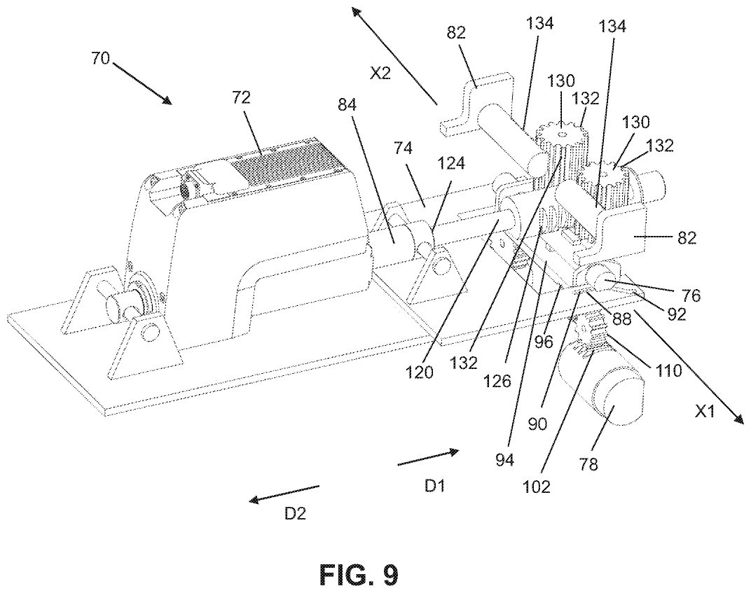

In one embodiment, the pin linkage gears 98 include two pin drive gears 104, 106 in meshed engagement with the pin linkage rack 94. Gear teeth 100 of one of the pin drive gears 104 may directly engage the pin teeth 102 of one of the cylinder pins 78. Gear teeth 100 of the other pin drive gear 106 may engage gear teeth 108 of a pin driven gear 110, and the gear teeth 108 of the pin driven gear 110 may engage the pin teeth 102 of another cylinder pin 78. Accordingly, lateral movement of the pin linkage rack 94 in a first lateral direction X1 (shown in FIG. 9) causes rotation of the pin drive gear 104 engaged with the cylinder pin 78, which causes the cylinder pin 78 to extend in a second lateral direction X2 opposite to the first lateral direction X1. Rotation of the pin drive gear 106 engaged with the driven gear 110 causes rotation of the driven gear 110, which in turn causes lateral movement of the other cylinder pin 78 to extend in the first lateral direction X1. Thus, the cylinder pins 78 may be moved in opposite lateral directions from respective pin retracted positions to respective pin extended positions. In the present examples, the pin linkage 76 is configured to cause simultaneous movement of the cylinder pins 78.

Conversely, lateral movement of the pin linkage rack 94 in the second lateral direction X2 causes rotation of the of the pin drive gear 104 engaged with the cylinder pin 78 which causes the cylinder pin 78 to retract in the first lateral direction X1. Rotation of the pin drive gear 106 engaged with the driven gear 110 causes rotation of the driven gear 110, which in turn causes lateral movement of the other cylinder pin 78 to retract in the first lateral direction X1. Thus, the cylinder pins 78 may be moved in opposite lateral directions from respective pin extended positions to respective pin retracted positions. In the present examples, the pin linkage 76 is configured to cause simultaneous movement of the cylinder pins 78.

It will be appreciated that in other embodiments, the pin linkage 76 may include two pin linkage racks 94, each engaged with a corresponding guide wall 88 of the operating plate 74. It will also be appreciated that pin linkage gears 98 may be interposed between the pin linkage rack or racks 94 and the cylinder pins 78 in suitable numbers and a suitable arrangement to provide lateral movement of the cylinder pins 78 in opposite lateral directions to extend and retract the cylinder pins 78.

The lock arm linkage 80 includes a lock arm rack 120 having a driven end 122 configured for selective engagement with a drive end 124 of actuator arm 84. The lock arm rack 120 includes lock arm rack teeth 126 arranged along at least a portion of the lock arm rack 120. The lock arm linkage 80 also includes lock arm drive gears 130 having gear teeth 132 engaged with the lock arm rack teeth 126. The section lock arms 82 each include lock arm teeth 134 configured for meshed engagement with the gear teeth 132 of the lock arm drive gears 130.

The lock arm rack 120 is configured for movement in the first direction D1 in response to the drive end 124 of actuator arm 84 engaging the driven end 122 of the lock arm rack 120, and further moving the actuator arm 84 in the first direction D1. Engagement between the lock arm rack teeth 126 and lock arm gear teeth 132 causes the lock arm drive gears 130 to rotate with movement of the lock arm rack 120 in the first direction D1. Rotation of the lock arm drive gears 130, by engagement with the lock arm teeth 134, causes the section lock arms 82 to move laterally inward, i.e., to retract to an unlocking position to unlock a biased section lock 58 of a telescope section 52. For example, the right-most section lock 58 of FIG. 4 is shown without a plate to illustrate biasing member 59, such as a spring. Biasing member 59 biases the section locks 58 towards an extended position. Movement of the lock arm rack 120 in the second direction D2 causes the lock arm drive gears 130 to rotate in an opposite direction which causes the section lock arms 82 to move laterally outward, i.e., to extend to a locking position to lock a section lock 58 of a telescope section 52.

In operation, with reference to FIGS. 5-7, the actuator arm 84 and operating plate 74 are movable together in the first and second directions D1, D2 to three positions: a retracted position, an intermediate (or neutral) position, and an extended position. In the retracted position, the cylinder pins 78 are in a pin retracted position and are not engaged with corresponding openings 56 of a telescope section 52, while the section lock arms 82 are extended in the locking position, which corresponds with a locked condition of the section locks 58. Thus, in the retracted position, the locking head system 70 is not coupled to a telescope section 52 (e.g., T5) while the telescope section 52 (e.g., T5) remains locked to an immediately outwardly adjacent telescope section 52 (e.g., T4) or the base section 50. Accordingly, the boom actuator system 54 may be extended or retracted to reposition the locking head system 70 relative to the telescope sections 52. In this manner, the locking head system 70 may be repositioned for a subsequent boom extend or boom retract operation.

In the illustrated examples, in the retracted position, the drive end 124 of the actuator arm 84 is spaced from the driven end 122 of the lock arm rack 120 and the pin linkage 76 is positioned to interact with the second segment 92 of the guide wall 88.

The lock head actuator 72 can be operated to extend the actuator arm 84 from the retracted position (FIGS. 5-7) to the intermediate, or neutral, position (FIGS. 8 and 9). In the intermediate position, the cylinder pins 78 are extended to engage corresponding openings of a telescope section 52 and the section lock arms 82 remain in the extended, or locking position, corresponding to a locked condition of a corresponding section lock 58 of a telescope section 52. Thus, in the intermediate (neutral) position, the locking head system 70 is coupled to an adjacent telescope section 52 while the adjacent telescope section 52 remains locked to the immediately outwardly adjacent telescope section 52 or base section 50. Accordingly, in the intermediate, or neutral, position, the telescope section 52 (e.g., T5) is locked to the outwardly adjacent telescope section 52 (e.g., T4) and coupled to the locking head system 70. Thus, the telescope section 52 (e.g., T5) is held against extending or retracting movements.

Movement of the actuator arm 84 and operating plate 74 from the retracted position (FIGS. 5-7) to the intermediate or neutral position (FIGS. 8 and 9) causes the second segment 92 to interact with the pin linkage 76 to move the pin linkage 76 in a lateral direction as the second segment 92 moves in the first direction D1. In the illustrated examples, movement to the intermediate position causes the pin linkage rack 94 to move in a first lateral direction X1 to rotate the pin linkage gears 98. The pin linkage gears 98 are rotatable to cause movement of the cylinder pins 78 from the pin retracted position to the pin extended position.

In addition, with movement of the actuator arm 84 and operating plate 74 from the retracted position to the intermediate, or neutral, position, the actuator arm 84 is moved in the first direction D1 such that the drive end 124 is moved toward the driven end 122. However, the actuator arm 84 reaches the intermediate position before the drive end 124 engages the driven end 122 and movement is halted before the drive arm 84 can displace the lock arm rack 120. Thus, the lock arm rack 120 is not moved in the first (or proximal) direction D1, with movement of the actuator arm 84 from the retracted position to the intermediate, or neutral, position. Accordingly, the section lock arms 82 are not moved from the locking position to an unlocking position with movement of the actuator arm 84 from the retracted position to the intermediate position.

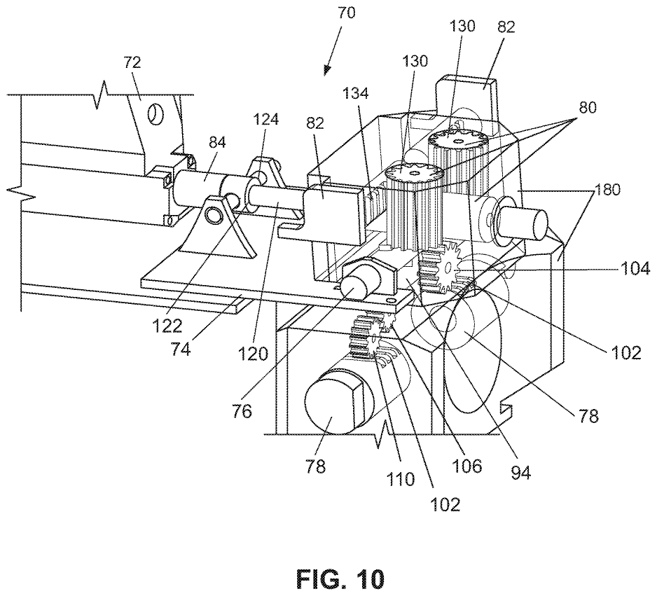

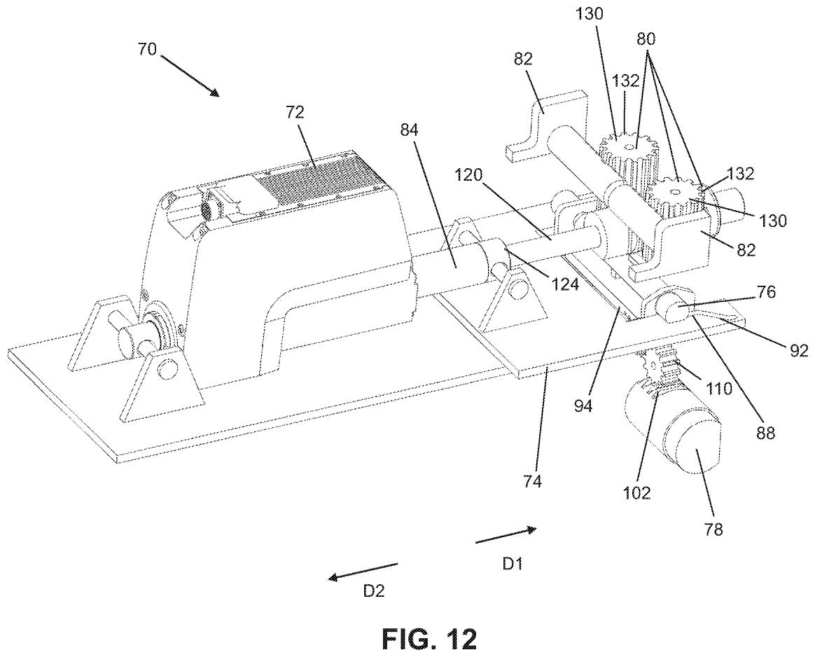

The lock head actuator 72 can be operated to extend the actuator arm 84 to move from the intermediate (neutral) position (FIGS. 8 and 9) to the extended position (FIGS. 10-12). In the extended position, the cylinder pins 78 remain extended to engage corresponding openings 56 of the telescope section 52 (e.g., T5) and the section lock arms 82 of T5 are moved to the unlocking position. Thus, in the extended position, the locking head system 70 is coupled to the adjacent telescope section 52, and the adjacent telescope section 52 (e.g., T5) is unlocked from the immediately outwardly adjacent telescope section 52 (e.g., T4). Accordingly, in the extended position, the boom actuator system 54 may be operated to extend or retract the telescope section 52 (e.g., T5) to which cylinder pins 78 are engaged.

Movement of the actuator arm 84 and operating plate 74 from the intermediate position (FIGS. 8 and 9) to the extended position (FIGS. 10-12) causes the first segment 90, which extends in the direction of movement of the actuator arm 84 and operating plate 74, to move along the pin linkage 76 without causing lateral movement of the pin linkage 76. Because the pin linkage 76 is not moved laterally, the pin linkage gears 98 are not rotated and the cylinder pins 78 remain in the pin extended position. The drive end 124 of the actuator arm 84 abuts the driven end 122 of the lock arm rack 120 such that movement of the actuator arm 84 from the intermediate position to the extended positions drives the lock arm rack 120 in the first, or proximal, direction D1 as well.

In the illustrated examples, movement of the lock arm rack 120 in the first direction D1 causes the lock arm drive gears 130 to rotate, which in turn, causes lateral movement of the section lock arms 82. With the section lock arms 82 engaged with corresponding section locks 58 of a telescope section 52, lateral movement of the section lock arms 82 from the locked position to the unlocked position causes the section locks 58 to move from the locked condition to the unlocked condition. In the illustrated examples, in the extended position, the drive end 124 of the actuator arm 84 abuts the driven end 122 of the lock arm rack 120 and may hold the lock arm rack 120 with the section lock arms 82 in the unlocking position against a return spring force, i.e., a spring force urging the lock arm rack 120 to move the second direction D2.

It will be appreciated that operation of the actuator arm 84 and operating plate 74 in the opposite (distal) direction, i.e., the second direction D2, facilitates corresponding opposite movement of the cylinder pins 78 and section lock arms 82. For example, movement of the actuator arm 84 and operating plate 74 from the extended position to the intermediate (neutral) position facilitates movement of the section lock arms 82 from the unlocking position to the locking position, while the cylinder pins 78 remain in the pin extended position. The lock arm rack 120 may be urged to move in the distal, or second, direction D2 by a return spring force from the biased section lock 58 when the actuator arm 84 and operating plate 74 are moved from the extended position to the intermediate position.

In addition, movement of the actuator arm 84 and operating plate 74 in the second direction D2 from the intermediate position to the retracted position causes the cylinder pins 78 to move from the pin extended position to the pin retracted position while the section lock arms 82 remain in the locking position.

The boom actuator system 54 and locking head system 70 may be operated in the following manner as one example of extending and retracting a telescope section 52. With the telescoping boom 36 fully retracted, the locking head system 70 is generally arranged near a proximal end of the boom actuator system 54 and adjacent to a proximal end 186 of the fifth telescoping section T5.

In the present examples, to extend the fifth telescoping section T5, the actuator arm 84 and operating plate 74 are moved from the retracted position to the intermediate position to extend the cylinder pins 78 into corresponding openings 56 of the fifth telescope section T5. The boom actuator system 54 is coupled to the fifth telescope section T5 by way of the cylinder pins 78 in the pin extended position. Next, the actuator arm 84 and operating plate 74 can be moved to the extended position to move the section lock arms 82 to the unlocking position. Accordingly, the section locks 58 of the fifth telescope section T5 may be unlocked from the proximal end 286 of the outwardly adjacent fourth telescope section T4. The boom actuator system 54 can be operated to extend the slide part 62 in the distal, or second, direction D2. The fifth telescope section T5, which is coupled to the slide part 62 and unlocked from the fourth telescope section T4, moves together with the slide part 62 in the second direction D2.

When the fifth telescope section T5 is extended to the selected boom length, the locking head system 70 can be operated to move from the extended position to the intermediate position to move the section lock arms 82 to the locking position. The section lock arms 82 operate the section locks 58 of the fifth telescope section T5 to move to the locking condition, which locks the fifth telescope section T5 to the fourth telescope section T4 at the selected boom extension length. The actuator arm 84 and operating plate 74 can moved from the intermediate position to the retracted position to move the cylinder pins 78 to the pin retracted position. Accordingly, the fifth telescope section T5 is locked to the fourth telescope section T4 at an extended boom position and the boom actuator system 54 is uncoupled from the fifth telescope section T5 because the locking head system 70 is uncoupled from the fifth telescope section T5. The slide part 62 can then be moved relative to the telescope sections 52, for example, in the proximal, first, direction D1 to return to a substantially retracted condition of the boom actuator.

The process in the example above relating to the fifth telescope section T5 can be repeated with the fourth telescope section T4 and subsequent telescope sections (e.g., T3, T2, T1) to continue extending the telescoping boom.

To retract the boom 36, for example with the fourth and fifth telescope sections T4, T5 extended, the actuator arm 84 and operating plate 74 can be in the retracted position and the slide part 62 of the boom actuator system 54 can be extended such that the locking head system 70 is adjacent to the proximal end 286 of the extended fourth telescope section T4. The actuator arm 84 and operating plate 74 may be moved from the retracted position to the intermediate position to extend the cylinder pins 78 and couple the fourth telescope section T4 to the slide part 62 via the locking head system 70. Next, the actuator arm 84 and operating plate 74 may be moved from the intermediate position to the extended position to move the section lock arms 82 to the unlocking position to unlock the section locks 58 on the fourth telescope section T4. With the fourth telescope section T4 unlocked from the outwardly adjacent third telescope section T3 and coupled to the slide part 62, the slide part 62 can be retracted to retract the fourth telescope section T4. The actuating arm 84 and operating plate 74 can then be moved from the extended position to the intermediate position to lock the fourth telescope section T4 to a proximal end 386 of the outwardly adjacent third telescope section T3. The actuator arm 84 and operating plate 74 can be further moved from the intermediate position to the retracted position to uncouple the fourth telescope section T4 from the slide part 62. The process may be repeated to retract subsequent telescope sections, such as the fifth telescope section T5 in this example.

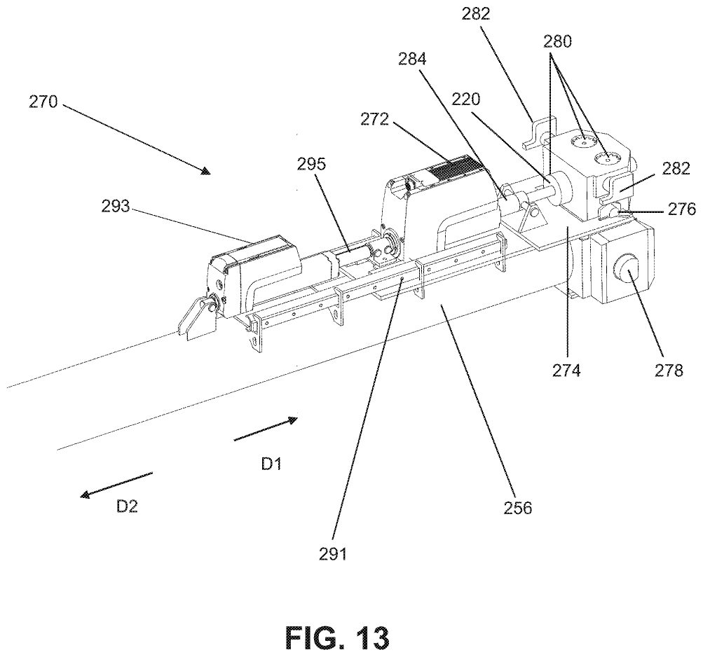

An additional locking head system embodiment is shown in FIG. 13. FIG. 13 includes a locking head system 270 with a first primary actuator 272 and a second secondary actuator 293 mounted on the telescoping member 256 on a track 291. The system 270 includes a first actuator arm 284 and a second actuator arm 295. The lock arm rack 220, lock arm linkages 280, section lock arms 282, pin linkage 276, cylinder pin 278, and operating plate 274 are arranged and function as described above in relation to locking head system 70 and their counterparts (which are numbered 120, 80, 82, 76, 78 and 74).

In normal operation of system 270, the primary actuator 272 is held in place (not sliding in track), with the secondary actuator 293 not moving. If the primary actuator 272 fails, then the secondary actuator 293 is used to move the primary actuator 272 in the track (with the primary actuator 272 not moving its actuator arm 284). In this way, the secondary actuator 293 moves the operating plate 274 and other components in the same way that the primary actuator 272 had been.

Accordingly, in the examples above, a locking head system may be provided which incorporates a rack and pinion to move cylinder pins and section lock arms and is electrically actuated. In this manner, drawbacks and conditions associated with hydraulic actuators, such as lurching, entrained air and cold weather may be avoided.

1. A crane comprising:
a carrier;
a superstructure mounted on the carrier, the superstructure comprising a telescoping boom having a base section and a plurality of telescope sections;
a boom actuator system comprising a telescoping member;
a lock head actuator on the telescoping member, the lock head actuator having an actuator arm configured to move in a first direction and a second direction opposite to the first direction;
an operating plate connected to the actuator arm and configured to move with the actuator arm, wherein the operating plate and actuator arm are moveable in the first direction from a retracted position to a neutral position and from the neutral position to an extended position;
cylinder pins operably connected to the operating plate by a pin linkage, wherein movement of the operating plate from the retracted position to the neutral position causes the cylinder pins to move from a pin retracted position to a pin extended position; and
section lock arms operably connected to the actuator arm by a lock arm linkage, wherein the movement of the actuator arm from the neutral position to the extended position causes the section lock arms to move from a locking position to an unlocking position,
wherein the actuator arm is spaced from the lock arm linkage moving from the retracted position to the neutral position and drives movement of the lock arm linkage moving from the neutral position to the extended position.

2. The crane of claim 1, wherein the lock arm linkage includes a lock arm rack and lock arm drive gears, and the section lock arms further include lock arm teeth.

3. The crane of claim 2, wherein the actuator arm engages a driven end of the lock arm rack to move the lock arm rack in the first direction when moving from the neutral position to the extended position.

4. The crane of claim 3, wherein the lock arm rack includes lock arm rack teeth, wherein movement of the lock arm rack in the first direction causes rotation of the lock arm drive gears by way of a meshed engagement between the lock arm rack teeth and lock arm gear teeth of the lock arm drive gears.

5. The crane of claim 4, wherein rotation of the lock arm drive gears caused by movement of the lock arm rack in the first direction causes lateral movement of the section lock arms from the locking position to the unlocking position by way of meshed engagement between the lock arm gear teeth and the lock arm teeth.

6. The crane of claim 5, wherein movement of the lock arm rack in the second direction from the extended position to the neutral position causes lateral movement of the section lock arms from the unlocking position to the locking position.

7. The crane of claim 1, wherein the pin linkage includes a pin linkage rack having pin rack teeth and pin linkage gears having gear teeth, wherein lateral movement of the pin linkage rack causes rotation of the pin linkage gears by meshed engagement between the pin rack teeth and the gear teeth.

8. The crane of claim 7, wherein the cylinder pins include pin teeth, and rotation of the pin linkage gears causes lateral movement of the cylinder pins from the pin retracted position to the pin extended position by meshed engagement between the gear teeth and the pin teeth when the operating plate is moved in the first direction from the retracted position to the neutral position.

9. The crane of claim 8, wherein movement of the operating plate in the second direction from the neutral position to the retracted position causes lateral movement of the cylinder pins from the pin extended position to the pin retracted position.

10. The crane of claim 1, wherein the cylinder pins are in the pin retracted position and the section lock arms are in the locking position when the actuator arm and operating plate are in the retracted position, the cylinder pins are in the pin extended position and the section lock arms are in the locking position when the actuator arm and operating plate are in the neutral position, and the cylinder pins are in the pin extended position and the section lock arms are in the unlocking position when the actuator arm and operating plate are in the extended position.

11. The crane of claim 1, comprising a secondary actuator coupled to the lock head actuator, wherein the secondary actuator is configured to move the lock head actuator.

12. A locking head system of a crane boom actuator system, the locking head system comprising:
a lock head actuator having an actuator arm configured to move in a first direction and a second direction opposite to the first direction;
an operating plate connected to the actuator arm and configured to move with the actuator arm, wherein the operating plate and actuator arm are moveable in the first direction from a retracted position to a neutral position and from the neutral position to an extended position;
cylinder pins operably connected to the operating plate by a pin linkage, wherein movement of the operating plate from the retracted position to the neutral position causes the cylinder pins to move from a pin retracted position to a pin extended position; and
section lock arms operably connected to the actuator arm by a lock arm linkage, wherein the movement of the actuator arm from the neutral position to the extended position causes the section lock arms to move from a locking position to an unlocking position,
wherein the actuator arm is spaced from the lock arm linkage moving from the retracted position to the neutral position and drives movement of the lock arm linkage moving from the neutral position to the extended position.

13. The locking head system of claim 12, wherein the lock arm linkage includes a lock arm rack and lock arm drive gears, and the section lock arms further include lock arm teeth.

14. The locking head system of claim 13, wherein the actuator arm engages a driven end of the lock arm rack to move the lock arm rack in the first direction when moving from the neutral position to the extended position.

15. The locking head system of claim 14, wherein the lock arm rack includes lock arm rack teeth, wherein movement of the lock arm rack in the first direction causes rotation of the lock arm drive gears by way of a meshed engagement between the lock arm rack teeth and lock arm gear teeth of the lock arm drive gears.

16. The locking head system of claim 15, wherein rotation of the lock arm drive gears caused by movement of the lock arm rack in the first direction causes lateral movement of the section lock arms from the locking position to the unlocking position by way of meshed engagement between the lock arm gear teeth and the lock arm teeth.

17. The locking head system of claim 16, wherein movement of the lock arm rack in the second direction from the extended position to the neutral position causes lateral movement of the section lock arms from the unlocking position to the locking position.

18. The locking head system of claim 12, wherein the pin linkage includes a pin linkage rack having pin rack teeth and pin linkage gears having gear teeth, wherein lateral movement of the pin linkage rack causes rotation of the pin linkage gears by meshed engagement between the pin rack teeth and the gear teeth.

19. The locking head system of claim 18, wherein the cylinder pins include pin teeth, and rotation of the pin linkage gears causes lateral movement of the cylinder pins from the pin retracted position to the pin extended position by meshed engagement between the gear teeth and the pin teeth when the operating plate is moved in the first direction from the retracted position to the neutral position.

20. The locking head system of claim 19, wherein movement of the operating plate in the second direction from the neutral position to the retracted position causes lateral movement of the cylinder pins from the pin extended position to the pin retracted position.

21. The locking head system of claim 12, wherein the cylinder pins are in the pin retracted position and the section lock arms are in the locking position when the actuator arm and operating plate are in the retracted position, the cylinder pins are in the pin extended position and the section lock arms are in the locking position when the actuator arm and operating plate are in the neutral position, and the cylinder pins are in the pin extended position and the section lock arms are in the unlocking position when the actuator arm and operating plate are in the extended position.

22. The locking head system of claim 12, comprising a secondary actuator coupled to the lock head actuator, wherein the secondary actuator is configured to move the lock head actuator.
